(19) United States
(12) Patent Application Publication
(10) Pub. No.: US 2006/0198251 A1
(43) Pub. Date: Sep. 7, 2006

(54) Method of opening tray of optical disc changer and method of reproduction data recorded on disc

(76) Inventor: Joung-Hoon Kim, Seoul (KR)

Correspondence Address: STEIN, MCEWEN & BUI, LLP, 1400 EYE STREET, NW, SUITE 300, WASHINGTON, DC, 20005, US

(21) Appl. No.: 10/553,233

(22) PCT Filed: Oct. 1, 2004
(86) PCT No.: PCT/KR04/02520

§ 371 Date: Oct. 14, 2005

(30) Foreign Application Priority Data
Oct. 7, 2003 (KR) 10-2003-0069725

(51) Int. Cl. G11B 17/22

(52) U.S. Cl. 369/30.32

(57) ABSTRACT

A method of opening a tray of an optical disc changer that includes a plurality of disc mounting recesses, on each of which a disc can be loaded, the method including moving two disc mounting recesses to a position that is exposed so that discs can be simultaneously mounted on the recesses when the tray is opened if a tray open command to mount two discs substantially simultaneously is input by a user, and opening the tray and a method of reproducing data on discs in an optical disc changer which is suitable for a tray open mode that enables two discs to be mounted simultaneously, the method including determining whether discs are mounted on pre-selected disc mounting recesses, reproducing a first disc having higher priority when whether discs are mounted on the selected two disc mounting recesses is determined, and reproducing a second disc when the reproduction of the first disc is completed.

### CROSS-REFERENCE TO RELATED APPLICATIONS

This application claims the benefit of PCT International Patent Application No. PCT/KR2004/0025210, filed Oct. 1, 2004, and Korean Patent Application No. 2003-69725, filed Oct. 7, 2003, in the Korean Intellectual Property Office, the disclosures of which are incorporated herein by reference.

### BACKGROUND OF THE INVENTION

1. Field of the Invention

An aspect of the present invention relates to an optical disc changer, and, more particularly, to an improved method of opening a tray of an optical disc changer that enables a loading of at least two discs substantially simultaneously, as well as a method of reproducing data that is recorded on the loaded optical discs.

2. Description of the Related Art

Compact disc changers, laser disc changers, compact disc graphic changers, and video compact disc changers have been developed and used as optical disc reproducing devices. Recently, digital video discs using motion picture experts group (MPEG) moving picture compression technology have been developed, and operations of the optical disc reproducing devices are improving.

In cases where an amount of data to be reproduced is large, such as in some movies, the amount of data to be reproduced requires the use of at least two discs and conventional optical disc reproducing devices that allow the loading of only one disc at a time. For example, a digital versatile disc (DVD) title generally includes two discs: disc A including a main feature and disc B including special features. However, in a conventional optical disc changer, discs are loaded one at a time, so loading a pair of discs (disc A and disc B) requires two loading processes. Also, when reproduction of data on disc A is completed, the user generally has to manipulate controls of the conventional optical disc changer to begin reproduction of data on disc B. As such, during a reproduction of the data, since a user may be required to change the discs during the reproduction, use of conventional optical disc reproducing devices is inconvenient.

Therefore, using an optical disc changer that includes a plurality of loaded discs (i.e., at least two discs) and selectively reproduces data recorded on a desired disc sequentially or at the discretion of the user with an optical disc reproducing device is advantageous. An example of one such optical disc changer is a roulette-type optical disc changer. The roulette-type optical disc changer includes a tray, on which a plurality of discs may be loaded, and selectively reproduces one of the loaded discs with one optical pickup by rotating the tray.

FIG. 1 is a perspective view illustrating the mechanical structure of a general roulette-type optical disc changer. The optical disc changer shown in FIG. 1 includes a main body 110, a tray 150 installed and housed in the main body 110, a roulette 160, on which a plurality of optical discs are mounted, rotatably installed on the tray 150, an optical pickup 120 that reads data from one of the optical discs mounted on the roulette 160, a clamp 130 that clamps the optical disc, and a clamp supporting board 131 that is installed on an upper portion of the optical pickup 120 and supports the clamp 130.

FIG. 2 is a block diagram illustrating the circuit structure of the optical disc changer shown in FIG. 1. As shown in FIG. 2, the optical disc changer includes an optical pickup 202, a radio frequency (RF) signal and servo signal processor 204, a motor and servo driving unit 206, a key input unit 208, a microprocessor 210, a digital signal processor 212, a motion picture experts group (MPEG) decoder 214, an audio signal processor 216, and a video signal processor 218.

The optical pickup 202 generates an RF signal corresponding to a signal recorded on the disc, which is loaded on the tray, and outputs the RF signal to the RF signal and servo signal processor 204. The RF signal and servo signal processor 204 amplifies the RF signal provided from the optical pickup 202, and provides the motor and servo driving unit 206 with a servo control signal corresponding to the RF signal. The motor and servo driving unit 206 drives a roulette motor and a spindle motor (not shown) to rotate the roulette, and performs tracking and focusing operations by driving a tracking actuator and a focus actuator (not shown) of the optical pickup 202. The digital signal processor 212 converts the amplified RF signal provided from the RF signal and servo signal processor 204 into a digital signal, performs an error detection and correction operation on the digital signal, and then outputs the digital signal to the MPEG decoder 214.

The MPEG decoder 214 decodes a digital audio signal and a digital video signal provided from the digital signal processor 212 using an MPEG compression format, and outputs the decoded audio signal to the audio signal processor 216 and the decoded video signal to the video signal processor 218. The audio signal processor 216 and the video signal processor 218 process the decoded digital audio signal and digital video signal, respectively, provided from the MPEG decoder 214, and output the processed signals to one or more speakers and a display device (not shown). The microprocessor 210 controls the optical disc changer to perform a disc reproduction operation and a tray opening/closing operation in response to commands input through the key input unit 208.

In the optical disc changer shown in FIGS. 1 and 2, a question of whether the disc is mounted should be determined while loading/unloading the disc. That is, when the disc tray is opened and closed, whether the disc is mounted on the disc mounting recess is determined by rotating the roulette 160. Also, information about the mounted disc, for example, table of contents (TOC) information, is read out and stored. Then, the optical disc changer goes into a standby state, waiting for input from the key input unit 208.

The discrimination of the disc mounting recess and the disc recognizing process are performed using a detection sensor. A plurality of recognition holes are formed around the disc mounting recess along a rotating trace of the tray in order to discriminate the disc mounting recess, and the detection sensor recognizes the disc mounting recess by determining the number of the recognition holes. Recognition of the disc mounting holes and control of disc mounting hole position are disclosed in Korean Laid-open Patent Nos. 2001-17235 (Mar. 5, 2001), 1999-12003 (Feb. 18, 1999), 1998-61647 (Oct. 7, 1998), 1998-61664 (Oct. 7, 1998), and 1998-69621 (Oct. 26, 1998).

The detection sensor determines whether a disc is mounted as well as a size of a mounted disc. In more detail, a light receiving sensor is disposed at a position where a light signal would be shielded by a mounted disc such that attempts to detect the light signal to determine whether a disc is mounted and the size of the disc result in the light receiving sensor not receiving the light signal indicating the presence of a mounted disc. The determination of whether a disc is mounted and the size of a mounted disc is disclosed in Korean Laid-open Patent Nos. 2002-49952 (Jun. 26, 2002), 1998-61650 (Oct. 7, 1998), and 1998-58828 (Oct. 7, 1998). The detection sensor to determine whether a disc is mounted and to recognize the disc mounting recess is generally installed around the optical pickup 202, that is, at a position corresponding to an innermost disc mounting recess of the disc changer.

When a command to open/close the tray is input, the roulette 160 rotates in one direction to position a disc mounting recess onto which a disc will be loaded or from which a disc will be unloaded at a loading/unloading position, and then the tray is opened. When a disc is loaded/unloaded and the tray is closed, the tray rotates in the opposite direction so that the disc mounting recess is positioned where the detection sensor is disposed. In the above process, whether a disc is mounted on the disc mounting recess is determined by the detection sensor.

FIG. 3 is a plan view of a conventional optical disc changer with a tray thereof opened. In the conventional optical disc changer, since only one disc mounting recess is fully exposed when the tray is opened as shown in FIG. 3, discs must be loaded/unloaded one at a time. Thus, the loading operation should be performed twice in order to reproduce a title including two discs (or three times, to reproduce a title including three discs, and so on), and the user generally has to manipulate controls to begin reproduction of data on disc B after reproduction of data recorded on disc A. In FIG. 3, a chucking point notifies the position on which the disc is reproduced.

### SUMMARY OF THE INVENTION

An aspect of the present invention provides an optical disc changer tray opening method that enables loading of at least two discs simultaneously.

An aspect of the present invention also provides a method of reproducing data recorded on at least two discs loaded on a tray of an optical disc changer by an optical disc changer tray opening method.

According to an aspect of the present invention, there is provided a method of opening a tray of an optical disc changer that includes a plurality of disc mounting recesses, on each of which a disc may be mounted, the method including: moving two disc mounting recesses to a position where they will both be exposed so that discs may be mounted on them simultaneously when the tray is opened, if a tray open command to mount two discs simultaneously is input by a user; and opening the tray.

According to another aspect of the present invention, there is provided a method of reproducing data from discs in an optical disc changer that is suitable for a tray open mode that enables two discs to be mounted simultaneously, the method including: determining whether discs are mounted on pre-selected disc mounting recesses; reproducing a first disc having higher priority when whether discs are mounted on the selected two disc mounting recesses is determined; and reproducing a second disc when reproduction of the first disc is competed.

According to an aspect of the present invention, two discs mounting recesses are exposed so that discs can be mounted on them simultaneously when the tray is opened.

According to an aspect of the optical disc changer tray opening method of the present invention, two discs may be mounted simultaneously when the tray is open to enhance convenience for the user.

Also, according to the method of reproducing data on a disc in the optical disc changer according to an aspect of the present invention, a title including two discs may be reproduced more conveniently.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating the mechanical structure of a general optical disc changer;

FIG. 2 is a block diagram illustrating the circuit structure of the optical disc changer shown in FIG. 1;

FIG. 3 is a plan view of a conventional optical disc changer with its tray open;

FIG. 4 is a plan view of an optical disc changer with its tray open according to an optical disc changer tray opening method of the present invention;

FIG. 5 is a flow chart illustrating an optical disc changer tray opening method according to an embodiment of the present invention;

FIG. 6 is a block diagram illustrating an apparatus that performs the optical disc changer tray opening method according to an embodiment of the present invention; and

FIG. 7 is a flow chart illustrating a method of reproducing data on discs in an optical disc changer according to an embodiment of the present invention.

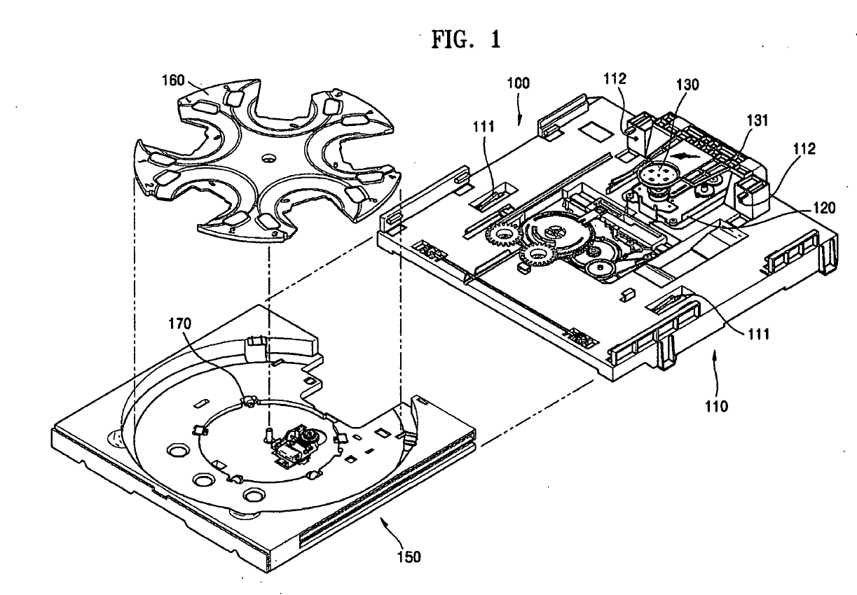

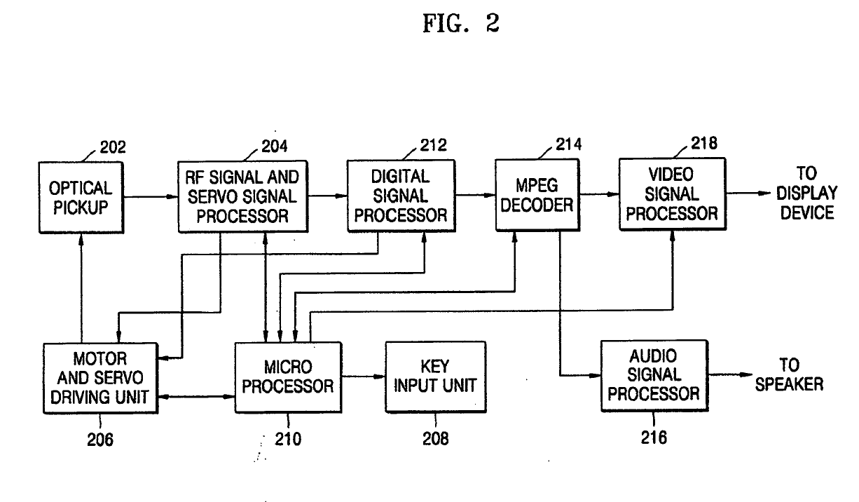

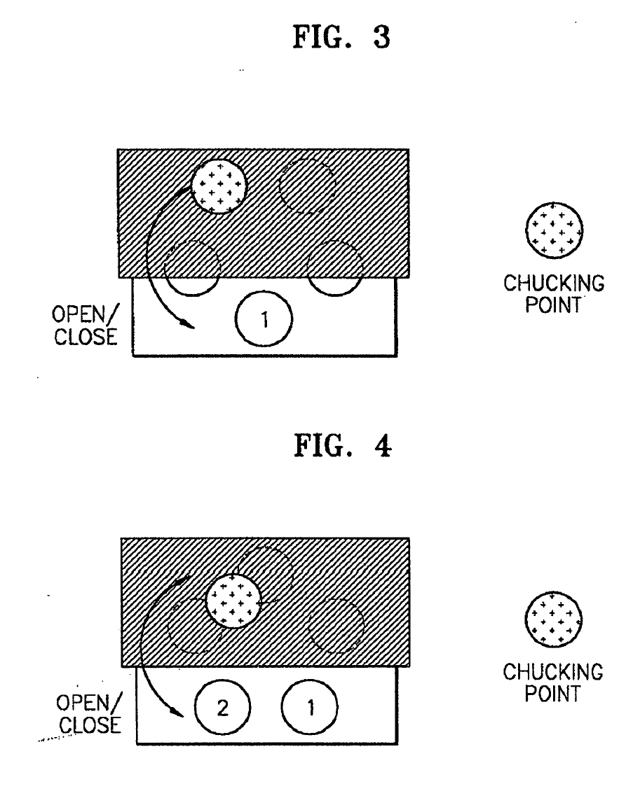

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 4 is a plan view of an optical disc changer with a tray thereof opened according to an optical disc changer tray opening method of the present invention. As shown in FIG. 4, since two disc mounting recesses are fully exposed when the tray is opened, two discs can be mounted substantially simultaneously. Of course, it is understood that more than two disc mounting recesses may be fully exposed and that more than two discs may be mounted substantially simultaneously. However, for the purposes of brevity, it is noted that only the embodiments of the invention in which two discs are mounted substantially simultaneously will be discussed.

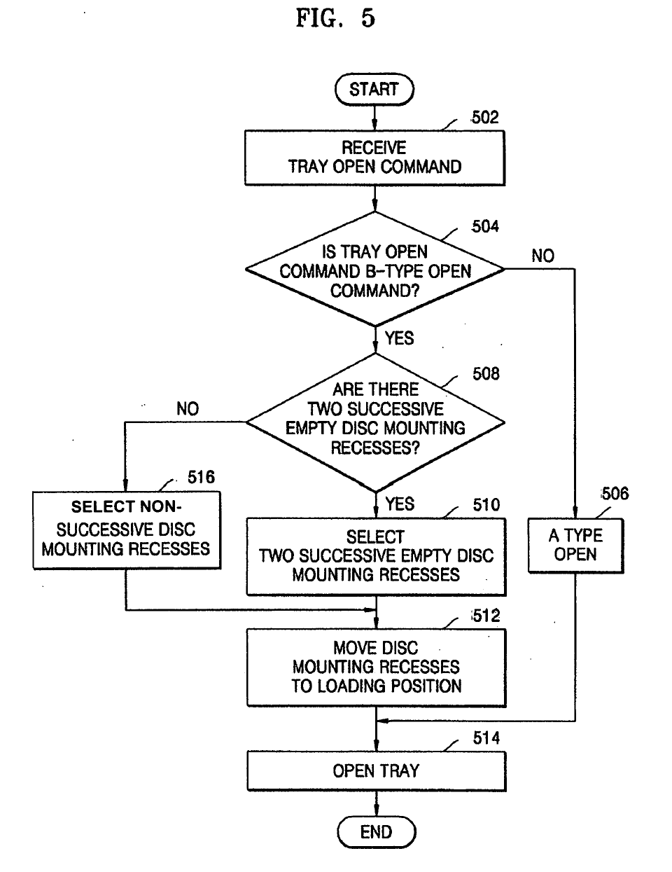

FIG. 5 is a flow chart illustrating an optical disc changer tray opening method according to an embodiment of the present invention. Here, a tray open mode that mounts only one disc at a time, as in the conventional art, will be referred to as an A-type open mode, and a tray open mode that enables mounting of two discs simultaneously, as in the present invention, is referred to as a B-type open mode. Commands to perform the modes will be referred to as an A-type open command and a B-type open command.

Referring to FIG. 5, a user inputs a tray open command (502). When the tray open command is input by the user, whether the open command is the A-type open command or the B-type open command (504) is determined. If the command is the A-type open command, the tray is opened according to the conventional method (506). Thus, only one disc may be mounted when the tray is opened. If the command is the B-type open command, the optical disc changer exposes two disc mounting recesses so that two discs may be mounted substantially simultaneously when the tray is opened.

In more detail, if the command is the B-type open command, the optical disc changer searches for two consecutive, empty disc mounting recesses (508). When two successive, empty disc mounting recesses are found, the two disc mounting recesses are selected and numbers of the selected disc mounting recesses are recorded (510).

Next, the two selected disc mounting recesses are moved to a position which is exposed when the tray is opened (i.e., a loading position) (512). For example, in a roulette-type optical disc changer, the roulette is rotated until the two disc mounting recesses selected in operation 510 are exposed when the tray is opened. That is, the roulette is rotated so that a center between the two disc mounting recesses selected in operation 510 is located at a center portion of an area to be exposed when the tray is opened.

In more detail, a distance between the center of the area to be exposed and a detection sensor is determined by the optical disc changer. The optical disc changer detects numbers of the disc mounting recesses passing through the detection sensor while rotating the roulette. The roulette is further rotated as much as the distance between the center of the area to be exposed and the detection sensor, after the first of the two disc mounting recesses passes through the detection sensor.

Next, the tray is opened (514). When the roulette rotates so that the center of the two disc mounting recesses is located at the center of the area to be exposed, the rotation is halted and the tray is opened so that the user can load discs. If no successive, empty recesses are found in operation 508, two successive disc mounting recesses are found. Then, the two successive disc mounting recesses are selected and numbers of the recesses are recorded (516). Then, operations 512 and 514 are performed so that the user may unload previously loaded discs and load new discs when the tray is open.

The loading positions of the discs and the reproducing order are closely related. In more detail, a condition in which the second disc (disc B) is mounted on the disc mounting recess that is detected earlier by the detection sensor due to the rotation of the roulette, and a condition in which the first disc (disc A) is mounted on the disc mounting recess that is detected later is desirable. Thus, the first disc (disc A) is detected and reproduced first.

In order to effectuate these conditions, symbols or numerals representing the loading order of the discs may be printed on a predetermined part of the tray to correspond with appropriate disc mounting recesses.

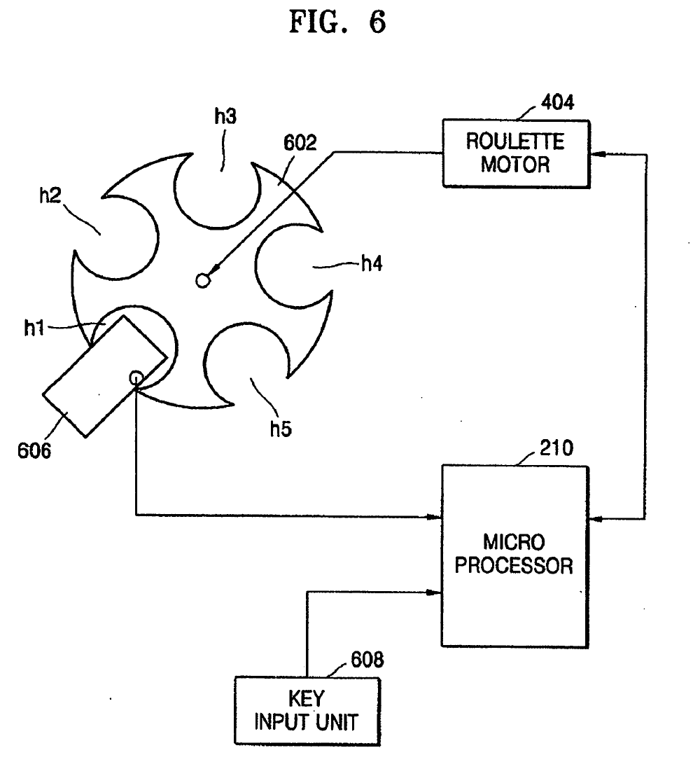

FIG. 6 is a block diagram illustrating an apparatus that performs the optical disc changer tray opening method according to an embodiment of the present invention. The apparatus includes a roulette 602 having a plurality of disc mounting recesses h1 through h5, a roulette motor 604 that rotates the roulette 602, a detection sensor 606 that recognizes the disc mounting recesses hi through h5 and determines whether a disc is mounted on each of them, a key input unit 608 through which commands are input by a user, and a microprocessor 610 that controls the roulette motor 604 according to tray open/close commands input through the key input unit 608.

When the user inputs the B-type open command through the key input unit 608, the microprocessor 610 controls the roulette motor 604 in response to the command so that two disc mounting recesses are moved to a loading/unloading position. Here, a condition in which the key input unit 608 comprises a separate key for the B-type open command is desirable. Alternatively, the B-type open command may be input by operating the same key used to input the A-type open command but in a different manner.

When the disc is loaded/unloaded and the tray is closed, the microprocessor 610 controls the roulette motor 604 to rotate the roulette 602 in order to determine whether discs are mounted on the disc mounting recesses. That is, when the B-type open command is applied, whether discs are mounted on the selected two disc mounting recesses is determined.

In process discussed above, the detection sensor 606 recognizes the disc mounting recesses that pass by when the roulette 602 rotates, and determines whether discs are mounted on the corresponding disc mounting recesses. The detection result of the detection sensor 606 is provided to the microprocessor 610.

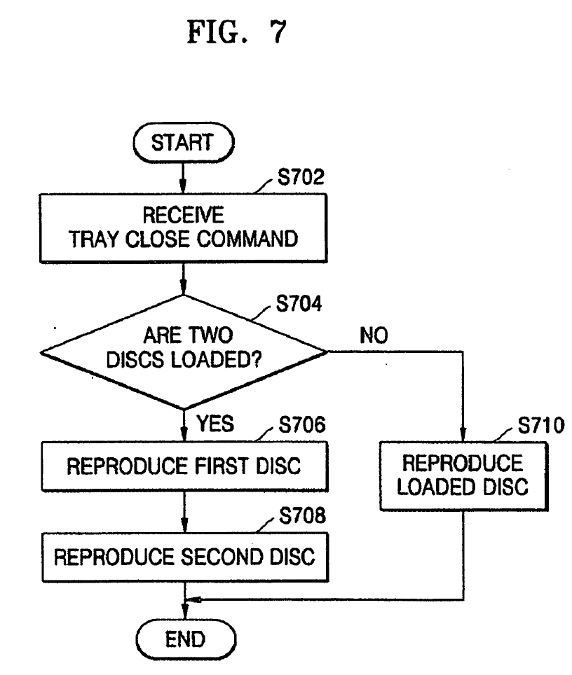

FIG. 7 is a flow chart illustrating a method of reproducing data on discs in an optical disc changer according to the present invention. Here, a condition in which two discs (disc A and disc B) are mounted by the B-type open command is assumed to have taken effect, and priority is set with respect to the discs. That is, that disc A has priority is assumed. The user then applies a tray close command (702). When the tray close command is received, whether discs are mounted on the disc mounting recesses which are selected when the B-type open command is applied (704) is determined. If discs are mounted on the two selected disc mounting recesses, the first disc (disc A) having higher priority is reproduced (706). When the reproduction of disc A is completed, the next disc (disc B) is reproduced automatically (708). If only one of the two disc mounting recesses has a disc mounted thereon is determined in operation 704, then only the mounted disc is reproduced (710).

Although a few embodiments of the present invention have been shown and described, it would be appreciated by those skilled in the art that changes may be made in these embodiments without departing from the principles and spirit of the invention, the scope of which is defined in the claims and their equivalents.

1. A method of opening a tray of an optical disc changer that includes a plurality of disc mounting recesses, on each of which a disc can be loaded, the method comprising:
if a tray open command for mounting two discs simultaneously is input by a user, moving two disc mounting recesses to a position that is exposed so that discs can be simultaneously mounted on the recesses when the tray is opened; and
opening the tray.

2. The method of claim 1, further comprising:
if the tray open command is applied, searching for two successive, empty disc mounting recesses and selecting the two successive, empty disc mounting recesses when they are found.

3. The method of claim 2, further comprising:
if two successive, empty disc mounting recesses are not found, selecting two successive disc mounting recesses which are not both empty.

4. A method of reproducing data on discs in an optical disc changer which is suitable for a tray open mode that enables two discs to be mounted simultaneously, the method comprising:
determining whether discs are mounted on pre-selected disc mounting recesses;
reproducing a first disc having higher priority when it is determined that discs are mounted on the selected two disc mounting recesses; and
reproducing a second disc when the reproduction of the first disc is competed.

5. The method of claim 4, wherein if only one of the disc mounting recesses has a disc mounted on thereon, the mounted disc only is reproduced.

6. An optical changer tray opening method, comprising:
inputting a tray open command to initiate an opening of a tray of the disc changer, the tray including multiple disc mounting recesses;
determining whether the tray open command initiates a multiple disc mounting mode;
opening the tray to expose multiple disc mounting recesses if the command initiates the multiple disc mounting mode.

7. The method according to claim 6, wherein the opening comprises rotating the tray to move the multiple disc mounting to an exposure position.

8. The method according to claim 6, further comprising searching for multiple consecutive, empty disc mounting recesses if the command initiates the multiple disc mounting mode.

9. The method according to claim 8, wherein, when multiple successive, empty disc mounting recesses are found, the method further comprises:
selecting the mutiple disc mouting recesses; and
recording numbers of the selected disc mounting recesses.

10. The method according to claim 9, wherein the method further comprises moving thne multiple selected disc mounting recesses to a loading position.

11. The method according to claim 10, wherein the moving comprises rotating a roulette wheel, in which the disc mounting recesses are defined, so that a center between the multiple selected disc mounting recesses is located at a center portion of an area to be exposed.

12. The method according to claim 11, further comprising:
detecting numbers of the disc mounting recesses during the rotating of the roulette; and
determining an amount of rotation that has occured based on the detection of the numbers of the disc mounting recesses.

13. The method according to claim 6, wherein if successive and empty disc mounting recesses are found, but two successive disc mounting recesses are found, the method further comprises:
selecting the two successive disc mounting recesses; and
recording numbers of the recesses.

14. The method according to claim 6, wherein the multiple discs include first and second discs and the nultiple disc recesses include first and second disc recesses in a roulette that are detected by the optical disc changer and wherein the method further comprises:
detecting a condition in which the second disc is mounted on the disc mounting recess that is detected earlier during a rotation of the eroulette; and
detecting a condition in which the first disc is mounted on the disc mouting recess that is detected later than earlier detected recess.

15. An optical changer, comprising:
a rotatable roulette having a pluarlity of disc mounting recesses;
a detection sensor to recognize the disc mounting recesses and determines whether a disc is mounted on each of them; and
a microprocessor to control the roulette motor according to tray opem/close commands inputted by a user, wherein when the user inputs a multiple disc mounting command, the microprocessor responsively contorls the roulette motor based on information received from the detection sensor so that multiple disc mounting recesses are moved to loading/unloading positions.

16. The changer according to claim 15, wherein the detection sensor recognizes the disc mounting recesses that pass by the sensor when the roulette rotates, and determines whether discs are mounted on the corresponding disc mounting recesses.

17. The changer according to claim 16, wherein results of the recognition and detection of the detection sensor is provided to the microprocessor.

18. A method of reproducing data on discs in an optical disc changer in which multiple discs are mounted on a roulette wheel of the changer, priority is established among the disks, and a multiple disc mounting mode has been initiated, the method comprising:
determining whether the discs are mounted on the disc mounting recesses which are selected when the multiple disc mounting mode has been initiated;
reproducing a first disc having high priority, if discs are mounted on the selected disc mounting recesses; and
automatically reproducing a second high priority disc when the reproduction of the first disc is completed, wherein if one of the two disc mounting recesses does not have a disc mounted thereon then only the mounted disc is reproduced.

19. An optical disc changer tray opening method, comprising:
inputting a tray open command to initiate an opening of a tray of the disc changer, the tray including multiple disc mounting recesses;
determining whether the tray open command initiates a multiple disc mounting mode or a signle disc mounting mode;
opening the tray to provide access to the disc mounting recesses; and
exposing multiple disc mounting recesses if the command initaites the multiple disc mounting mode or exposing one multiple disc mounting recess if the tray open command initiates sa single disc mounting mode.

20. An optical disc changer tray opening method, comprising:
inputting a tray open command to initiate an opening of a tray of the disc changer, the tray including multiple disc mounting recesses;
deteremining whether the tray open command initiates a multiple disc mounting mode or a signle disc mounting mode;
opening the tray to expose multiple disc mounting recesses if the command initiates the mutiple disc mounting mode or to expose one multiple disc mounting recss if the tray open command initiates a single disc mounting mode.
